(19) United States
(12) Patent Application Publication
(10) Pub. No.: US 2024/0343576 A1
(43) Pub. Date: Oct. 17, 2024

(54) MONO PRESSURE SYSTEM FOR PRODUCING NITRIC ACID AND METHOD OF OPERATING THEREOF

(71) Applicant: Yara International ASA, Oslo (NO)

(72) Inventors: Bent VIGELAND, Skien (NO); Halvor ØIEN, Porsgrunn (NO); Peter FAUCONNIER, Grimbergen (BE); Andre DE SMET, Terneuzen (NL)

(21) Appl. No.: 18/291,820

(22) PCT Filed: Aug. 25, 2022
(86) PCT No.: PCT/EP2022/073643

§ 371 Date: Jan. 24, 2024

(30) Foreign Application Priority Data
Aug. 25, 2021 (EP) 21193034.2
Jan. 11, 2022 (EP) 22150921.9

(51) Int. Cl. C01B 21/28; B01D 53/56

(52) U.S. Cl. CPC C01B 21/28; B01D 53/56; B01D 2257/404; B01D 2258/02

(57) ABSTRACT

A system for producing nitric acid at reduced power, the system being a standard mono pressure nitric acid plant wherein the system further includes features for splitting a tail gas into a first tail gas stream in fluid communication with an oxygen-rich gas upstream the ammonia mixing unit, and a second tail gas stream, features for pressurizing a gas downstream the absorption tower, such that an air compressor is not required. A method for operating the system, the use of the system for performing the method, and a method for revamping a standard mono pressure nitric acid plant into the system.

### FIELD

The present disclosure relates to the field of nitric acid production in a mono pressure plant.

### BACKGROUND

Pure nitric acid is a clear, colorless liquid with a strong odor. Nitric acid is produced in large quantities principally by catalytic oxidation of ammonia (Ostwald process). Ammonia is converted to nitric acid in several stages. The ammonia is first oxidized in an ammonia burner on platinum gauzes (commonly called ammonia converter) or cobalt balls, producing nitric oxide (in this disclosure also called nitrogen monoxide (NO)) and water:

$$\\ \begin{matrix}4 {NH}_{3} ( g ) + 5 {O}_{2} ( g ) \to 4 NO ( g ) + 6 {H}_{2} O ( g ) & ( 1 )\end{matrix}$$

The reaction product from (1), nitric oxide, following cooling, is then oxidized to nitrogen dioxide (NO₂) and further to dinitrogen tetroxide N₂O₄ (g) in an oxidation section:

$$\\ \begin{matrix}2 NO ( g ) + {O}_{2} ( g ) \to 2 {NO}_{2} ( g ) & ( 2 )\end{matrix}$$

$$\\ \begin{matrix}2 {NO}_{2} ( g ) \to {N}_{2} {O}_{4} ( g ) & ( 3 )\end{matrix}$$

Cooling of nitrogen oxide gases is accomplished first through the use of a waste heat recovery system recovering the heat from the conversion of ammonia into nitric oxide, then through the use of a cooler condenser in which condensed nitric acid is separated from nitric oxide, nitrogen dioxide and dinitrogen tetroxide and nitric acid gases, collectively called NOx gases, and finally by heating the tail gas released at the outlet of the absorption tower in which the NOx gases are absorbed.

By absorption in water, nitrogen dioxide and dinitrogen tetroxide are converted to nitric acid and nitric oxide:

$$\\ \begin{matrix}3 {NO}_{2} ( g ) + {H}_{2} O ( l ) \to 2 {HNO}_{3} ( aq ) + NO ( g ) & ( 4 )\end{matrix}$$

$$\\ \begin{matrix}3 {N}_{2} {O}_{4} ( g ) + 2 {H}_{2} O ( l ) \to 4 {HNO}_{3} ( aq ) + 2 NO ( g ) & ( 5 )\end{matrix}$$

Weak nitric acid which is up to 68% (azeotrope) is obtained. Through a rectification process the concentration of nitric acid can be increased up to 99% concentrated nitric acid. The total reaction is given by the following formula:

$$\\ \begin{matrix}{NH}_{3} + 2 {O}_{2} \to {HNO}_{3} + {H}_{2} O & ( 6 )\end{matrix}$$

The main process units in a nitric acid production plant, include an ammonia converter (conversion of ammonia into nitric oxides using oxygen over a suitable catalyst), an oxidation section (conversion of nitric oxide into nitrogen dioxide and nitrogen tetroxide), an absorber unit (for the absorption of NOₓ gases into water) and a bleacher unit (removal of unreacted dissolved gases, containing in particular NOₓ and gases, from the aqueous nitric acid solution, which give it its typical brownish color).

The process for the production of nitric acid can be differentiated into a mono-pressure (single-pressure) and dual pressure (split-pressure) process.

In a mono-pressure process, the converter and the absorber unit operate at roughly the same working pressure P1. Such mono-pressure process generally includes low-pressure (2 to 6 bara) and high-pressure (from above 6 to 16 bara, in particular 9 to 16 bara) processes.

The drive power for the air compressor typically originates from a tail-gas turbine and a steam turbine or electric motor. Accordingly, the compressor train of mono pressure nitric acid production plant typically comprises an air compressor, a tail-gas turbine, and a steam turbine or electric motor.

More in detail, referring to FIG. 1, a mono pressure plant and process according to the prior art works as follows. Gaseous ammonia 32, optionally pre-heated in a pre-heater unit (not shown) is mixed with compressed air 34 pressurized using an air compressor 36, in a mixing apparatus 35, and the resulting ammonia/oxygen-enriched air mixture 14 is fed to an ammonia converter 37, where ammonia is oxidized over a suitable catalyst, thus obtaining a NOₓ gas/steam mixture 15, comprising water and nitric oxide (NO). Typically, the air compressor has a capacity of at least 300000 m³/h. The heat of the mixture coming out of the ammonia converter is recovered, after which the NOₓ gas/stream mixture is subsequently cooled down in a gas cooler/condenser 38 to a temperature where the water condenses, and an aqueous diluted nitric acid mixture 17 is separated from a gaseous NOₓ stream 22. The gaseous NOₓ stream is further oxidized to further convert the NO to NO₂ and N₂O₄ to separate out another aqueous diluted nitric acid mixture 17 which is directed to an absorption tower 41, commonly called absorption tower. On the other end, the gaseous NOₓ stream 22 is sent to the absorber unit 41 too. Inside the absorber unit 41, the NOₓ gas reacts with water to produce the tail gas 5 and a stream of raw nitric acid 27 also containing residual NOₓ gas, which is fed to a bleacher 57. The residual NOₓ gas in the raw nitric acid stream 27 is then stripped out with a gaseous medium 60 such as an oxygen-containing gas or air, inside the bleacher 57; the bleacher unit is generally operated at about the same pressure as the ammonia converter. The drive power for both the air compressor 36 originates from a tail gas expander 7 and a steam turbine 51 or electric motor (not shown). The tail gas 5 exchanges heat with the NOₓ gas/steam mixture 15 in the tail gas heater 43 and is expanded in the tail gas expander 7.

The air used for the oxidation of ammonia is commonly denoted as primary air; the air used as stripping medium in the bleacher unit is commonly denoted as secondary air.

According to the prior art, the revamping of the nitric acid production plants to increase its capacity is commonly based on increasing the amount of primary air to the reactor, which leads to a proportional increase of the amount of nitric acid produced.

The increase of the amount of primary air in the reactor entails the installation of a new air compressor or the revamping of the existing one. This revamping has significant drawbacks. First of all, it entails elevated costs for the modification or replacement of the existing equipment, i.e. the air compressor and the corresponding turbines and electrical motor. In addition, the revamping of the equipment is also technically demanding, leading to long plant downtime.

Another problem related to nitric acid production plants is the high amount of energy required in order to operate the air compressor. Consequently, a high amount of energy is required to achieve the targeted nitric acid production throughput.

A goal of the present invention, therefore, is to provide a system and a method for operating the system which allows for the reduction or even suppression of power required to operate the air compressor in a mono nitric acid plant.

In CN110540178A (China Chengda Engineering Co Ltd, 2019), process for producing nitric acid is disclosed. Nitric acid is produced by a medium pressure method, which is characterized in that it comprises the following steps: the ammonia oxidation and absorption pressure is 0.5-0.6 MPa; enabling the tail gas leaving the absorption tower to pass through a carbon molecular sieve Temperature Swing Adsorption (TSA) treatment device to reduce the content of nitrogen oxides in the tail gas to be less than 100 mg/Nm³; the process air of the air compressor is used as the regeneration desorption gas of the carbon molecular sieve temperature swing adsorption treatment device, and the regeneration desorption gas containing the nitrogen oxide can be returned to the ammonia oxidation reactor for reuse; adding a layer of N₂O decomposition catalyst in the oxidation reactor to reduce the content of N₂O to 50-100 PPM through reaction; the nitric acid bleaching tower is arranged at the bottom of the absorption tower, and the two towers are integrated, so that the process flow is shortened, and the equipment investment is reduced. With regard to the amount of air being compressed by the air compressor, however, the same amount of air is to be compressed as would be in the absence of the TSA unit: in the presence of the TSA unit, the amount of air being compressed is initially split between the TSA unit and the ammonia oxidation reactor directly and, in the end, with the amount of compressed air leaving the TSA unit being directed also to the ammonia oxidation reactor, the total amount of air compressed by the air compressor ends up in the ammonia oxidation reactor.

In WO2018/162150A1 (Casale SA, 13 Sep. 2018) a solution is proposed to overcome the revamping drawbacks. WO2018162150A1 discloses a dual pressure plant for the production of nitric acid comprising a reactor providing a gaseous effluent containing nitrogen oxides, an absorber unit in which nitrogen oxides react with water providing raw nitric acid and, the absorber unit operating at a pressure greater than the pressure of the reactor, a compressor elevating the pressure of the reactor effluent to the absorber unit pressure, the plant also comprising a first HP bleacher unit and a second LP bleacher unit, the first HP bleacher unit stripping with air the NOₓ gas from the output stream of the absorber unit, thus providing a partially stripped nitric acid stream and a nitrogen oxides-loaded air stream, the former being fed to the second LP-bleacher unit and the latter being recycled to the oxidation section, upstream of the NOₓ gas compressor.

A further air compressor is also provided, which supplies the first HP bleacher unit with air. Hence, energy is required in order to operate a first HP bleacher unit at a high-pressure and then recycle NOₓ gases to the delivery side of the NOₓ gas compressor.

Therefore, there remains a need for a process and a corresponding plant setup for minimizing or even suppressing the amount of energy required in order to operate the air compressor, in order to avoid bottle-necks in the nitric acid production throughput associated with those compressors.

### SUMMARY

In one aspect of the disclosure a production plant for producing nitric at reduced power consumption and reduced emissions, is disclosed. The production plant comprises, optionally, a source of pressurized air in fluid communication with the production plant comprising:
a source of an oxygen-rich gas, particularly a source of a pressurized oxygen-rich gas, such as a high-pressure water electrolyzer;
a mixing apparatus downstream the source of the oxygen-rich gas, for mixing a first oxygen-containing gas with an ammonia gas stream, to produce an ammonia/oxygen-containing gas mixture;
an ammonia converter operable at a pressure P1, for oxidising ammonia in the ammonia/oxygen-containing gas mixture, to produce a NOₓ gas/steam mixture, comprising water and nitric oxide;
a means for regulating the concentration of ammonia and/or of oxygen in the ammonia converter, particularly a means for controlling the flow of the oxygen-rich gas and/or a means for controlling the flow of the ammonia gas stream, for maintaining the oxygen to ammonia molar ratio inside the ammonia converter at a ratio of at least 1.2, in particular between 1.2 and 9 or between 1.25 and 9;
a gas cooler/condenser downstream the ammonia converter, to produce an aqueous diluted nitric acid mixture and a gaseous NOₓ stream;
an absorption tower, downstream the gas cooler/condenser, for absorbing the NOₓ gases from the gaseous NOₓ stream in water, to produce a stream of raw nitric acid containing residual NOₓ gas and a tail gas comprising NOₓ gases, comprising an absorption tower tail gas outlet for evacuating the tail gas;
a supply for a second oxygen-containing gas, for supplying oxygen to a NOₓ gas containing stream between the ammonia converter and the absorption tower, for obtaining a tail gas containing at least 0.5% by volume oxygen; and
a tail gas heater, positioned upstream from the gas cooler/condenser, for heating a tail gas stream with the heat from the NOₓ gas/steam mixture coming from the ammonia converter;
   characterized in that the system further comprises:
a means for splitting a tail gas into a first tail gas stream and a second tail gas stream, wherein the first tail gas stream is in fluid communication with the oxygen-rich gas, and wherein the mixing of the oxygen-rich gas and the first tail gas stream provides the first oxygen-containing gas; and
a means for pressurizing a gas, located anywhere located anywhere in the fluid communication between the absorption tower and the mixing apparatus, or anywhere between the ammonia converter and the absorption tower, to provide the first tail gas stream at a pressure P1.

The inventors have found that, instead of continuously supplying pressurized air provided by an air compressor as primary air to the mixing unit at a pressure P1, it is possible to recirculate the first tail gas stream provided by the means for splitting at a pressure P1, particularly when combined with, at the same time, providing oxygen, particularly pressurized oxygen, to the system. Therefore, compressed or pressurized air only has to be supplied in order to start the process, in particular to pressurize the plant or system, but no longer after the production of the tail gas has started and an air compressor is not required for operating the nitric acid production plant. More in particular, an air compressor suitable for pressurizing the plant or system has a capacity of 2000 to 19000 m³/h, which is much smaller than an air compressor for operating a prior art nitric acid plant, with a capacity of at least 300000 m³/h. In addition, the first oxygen-rich gas having a pressure P1 and the supply of a second oxygen-rich gas provide oxygen to the ammonia converter and to the absorption tower, respectively, such that, in the absence of the primary and secondary air provided by the air compressor, the concentration of oxygen in the ammonia converter and in the absorption tower is similar to that in a standard dual pressure nitric acid plant.

In the absence of an air compressor and with the additional tail gas stream being recirculated in the system, not only is the power demand of the system reduced: the NOₓ emissions leaving the system are also reduced. Therefore, the size of the treatment unit for treating those NOₓ emissions is reduced with respect to the size in the corresponding standard mono pressure nitric acid plant. The system of the present disclosure thus achieves a significant power reduction together with a reduction of the area footprint of the plant and the simplification of the system, by the removal of the air compressor and reducing the size of the tail gas expander. In addition, the separate supply of the pressurized oxygen or oxygen-rich gas ensures an optimal conversion of ammonia to nitric oxide.

In one embodiment according to the production plant of the disclosure, the system further comprises one or more of:
a heat exchanger, for exchanging heat between the tail gas and the stream of tail gas exiting the tail gas heater, wherein the means for splitting is positioned downstream the heat exchanger, and wherein the means for pressurizing is located upstream the heat exchanger;
a De-NOₓ treatment unit; and
a steam turbine, wherein the steam turbine can at least partly power the means for pressurizing.

In one embodiment according to the production plant of the disclosure, the production plant further comprises a bleacher comprising an inlet for an oxygen-rich bleaching gas, and an outlet for bleaching gases or off-gases, and wherein the bleaching gases or off-gases are in fluid communication with any stream between the ammonia converter and the absorption tower, such that the second oxygen-containing gas is at least partly provided by the bleaching gases or off-gases.

In one embodiment according to the production plant of the disclosure, part of the oxygen-rich gas or part of the oxygen-containing gas or part of the tail gas, is in fluid communication with the inlet of the bleacher, such that the oxygen-rich bleaching gas or stripping gas is at least partly provided by part of the oxygen-rich gas or part of the first oxygen-containing gas or part of the tail gas stream downstream the means for pressurizing.

In one embodiment according to the production plant of the disclosure, the oxygen-rich gas, the second oxygen-containing gas, the oxygen-rich bleaching gas and the oxygen-rich off-gases are all at least partly provided by a high pressure water electrolyzer.

In one embodiment according to the production plant of the disclosure, the production plant further comprises a tail gas expander for expanding the second tail gas stream to atmospheric pressure, to produce an expanded tail gas, wherein the means for pressurizing can be powered by the tail gas expander or by the steam turbine or by a power source.

In one embodiment according to the production plant of the disclosure, the plant further comprises a source of pressurized air in fluid communication with the system of the present disclosure, wherein the fluid communication between the source of pressurized air and the system is in direct fluid communication with the oxygen-rich gas.

In one aspect of the disclosure, a method for producing nitric acid at reduced power consumption and reduced emissions, in a production plant according to the production plant of the disclosure, is disclosed. The method comprises the steps of:

comprising the steps of:
prior to step c) providing or preparing an oxygen-rich gas and a first oxygen-containing gas, and providing an ammonia gas stream;
a) particularly, pressurizing the production plant or system of the present disclosure, such as by supplying pressurized air having a pressure P1 in the system of the present disclosure;
b) particularly, inducing a pressurized air flow in the system by operating a means for pressurizing using external power;
c) supplying the ammonia gas stream and a first oxygen-containing gas to the mixing apparatus, thereby producing the ammonia/oxygen-containing gas mixture;
d) oxidizing ammonia in the ammonia/oxygen-containing gas mixture in the ammonia converter at a pressure P1, thereby producing a gaseous NOx gas/steam mixture, comprising water and nitric oxide;
e) separating and condensing steam in the gas cooler/condenser, thereby generating an aqueous diluted nitric acid mixture and a gaseous NOx stream;
f) absorbing the gaseous NOx stream in the absorption tower, thereby producing the stream of raw nitric acid containing residual NOx gas and the tail gas comprising NOₓ gases; and
g) heating the tail gas in the tail gas heater with the gaseous NOₓ gas/steam mixture; characterized in that the method further comprises the steps of:
h) pressurizing a gas stream located anywhere downstream the absorption tower, or anywhere between the ammonia converter and the absorption tower, or upstream the ammonia converter in the first oxygen-containing stream or in the ammonia/oxygen-containing gas mixture, to a pressure P1 with the means for pressurizing;
i) splitting the tail gas with the means for splitting into a first tail gas stream and a second tail gas stream; and mixing the first tail gas stream with the oxygen-rich gas, thereby obtaining the first oxygen-containing gas;
k) adjusting the flow of the oxygen-rich gas being mixed in step i) or the flow of the ammonia gas stream in step c), such as to maintain the oxygen to ammonia molar ratio inside the ammonia converter at a ratio of at least 1.2, particularly between 1.2 and 9 or between 1.25 and 9; and
o) adjusting the flow of a second oxygen-containing gas, for obtaining a tail gas stream containing at least 0.5% by volume oxygen.

In one embodiment according to the method of the disclosure, in step h), at least part of the tail gas obtained from step f) is pressurized in the means for pressurizing, thereby generating a pressurized tail gas, and wherein the method further comprises the steps of:
(h1) heating the pressurized tail gas with a tail gas stream downstream the tail gas heater and to be split in step i), in the heat exchanger, thereby bringing the tail gas to be mixed in step i) to a temperature below 300° C.;
m) treating the tail gas in the De-NOₓ treatment unit before step g) and after step h1); and
n) recovering at least part of the steam generated in the ammonia converter in the steam turbine.

In one embodiment according to the method of the disclosure, the method further comprises the step of:
r) bleaching the stream of raw nitric acid containing residual NOₓ gas in a bleacher, thereby producing the bleached nitric acid.

In one embodiment according to the method of the disclosure, the method further comprises the step of:
s) supplying part of the oxygen-rich gas or part of the first oxygen-containing gas obtained in step i) or part of the tail gas obtained in step g), to the inlet of the bleacher in step r).

In one embodiment according to the method of the disclosure, the method further comprises the steps of:
t) operating a water electrolyzer, thereby producing oxygen, particularly pressurized oxygen; and
u) providing, from the oxygen produced by the water electrolyzer in step t), at least part of the oxygen-rich gas, the second oxygen-containing gas, the oxygen-rich bleaching gas and the oxygen off-gases.

In one embodiment according to the method of the disclosure, the method further comprises the step of:
v) expanding the second tail gas stream in the tail gas expander to atmospheric pressure, thereby producing the expanded tail gas.

In one embodiment according to the method of the disclosure, in step a), the pressurized air is supplied in the stream in direct fluid communication with the oxygen-rich gas.

In one aspect of the disclosure, the use of the production plant of the disclosure for performing the method of the disclosure, is disclosed.

In a further aspect of the disclosure, a method for revamping a production plant for producing nitric acid into a production plant according to the present disclosure is disclosed, wherein the production plant comprises:
an air compressor for providing compressed air, particularly having a capacity of at least 300000 m³/h;
a mixing apparatus for mixing compressed air with an ammonia gas stream, to produce an ammonia/oxygen-containing gas mixture;
an ammonia converter, for oxidising ammonia in the ammonia/oxygen-containing gas mixture, to produce a NOₓ gas/steam mixture comprising water and nitric oxide;
a gas cooler/condenser downstream the ammonia converter, to produce an aqueous diluted nitric acid mixture and a gaseous NOₓ stream;
an absorption tower, downstream the gas cooler/condenser, for absorbing the NOₓ gases from the gaseous NOₓ stream in water, to produce a stream of raw nitric acid containing residual NOₓ gas and a tail gas comprising NOₓ gases, comprising an absorption tower tail gas outlet for evacuating the tail gas; and
a tail gas heater, positioned upstream from the gas cooler/condenser, for heating a tail gas stream with the heat from the NOₓ gas/steam mixture coming from the ammonia converter.

The revamping method is characterized in that it comprising the steps of:
introducing a source of pressurized air in fluid communication with the production plant, for pressurizing the production plant during start-up;
introducing a supply or source for an oxygen-rich gas, such as a high pressure water electrolyzer, the mixing of the oxygen-rich gas and of compressed air providing part of a first oxygen-containing gas;
introducing a supply for second oxygen-containing gas, for supplying oxygen between the ammonia converter and the absorption tower, such that a tail gas stream contains at least 0.5% by volume oxygen;
introducing a means for regulating the concentration of oxygen in the ammonia converter and/or of the ammonia gas stream, particularly a means for controlling the flow of the oxygen-rich gas and/or a means for controlling the flow of the ammonia gas stream, for maintaining the oxygen to ammonia molar ratio inside the ammonia converter at a ratio of at least 1.2;
introducing a means for splitting a tail gas stream into a first tail gas stream and a second tail gas stream, wherein the first tail gas stream is in fluid communication with the oxygen-rich gas, thereby providing the first oxygen-containing gas;
introducing a means for pressurizing a gas to a pressure P1 located anywhere in the fluid communication between the absorption tower and the mixing apparatus, or between the ammonia converter and the absorption tower, such as to provide the first tail gas stream at a pressure P1; and
removing the air compressor.

### BRIEF DESCRIPTION OF THE FIGURES

FIG. 1 schematically shows a nitric acid plant according to the prior art.

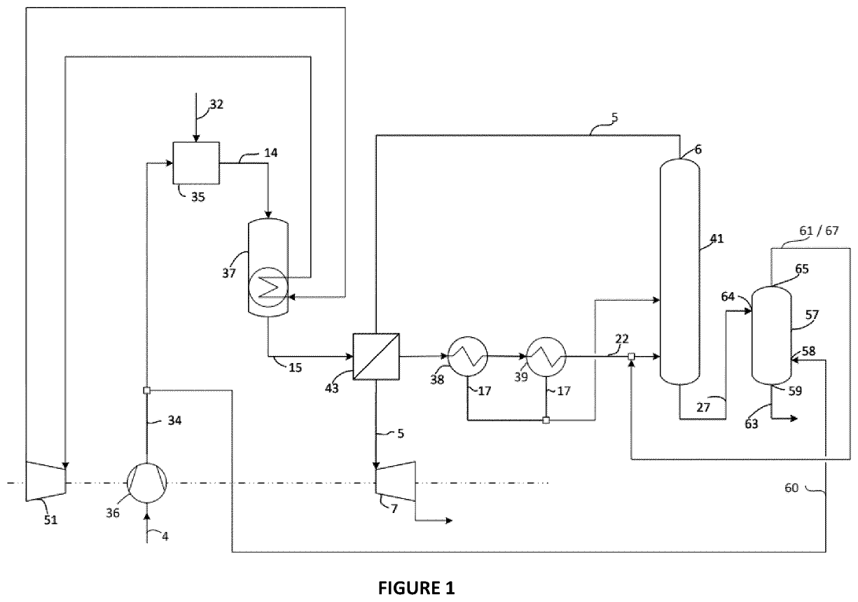

FIG. 2A schematically shows a nitric acid plant according to the disclosure, particularly wherein oxygen is supplied upstream the absorption tower (via 67).

FIG. 2B schematically shows a nitric acid plant according to the disclosure, particularly comprising a bleacher, wherein the oxygen is fist supplied as the stripper gas in the bleacher, and wherein the oxygen-containing bleacher off gas is supplied upstream the absorption tower.

Table of numerals

| | |
|---|---|
| 4 | air |
| 5 | tail gas stream, particularly exiting the absorber |
| 6 | outlet of nitric acid absorption tower |
| 7 | tail gas expander |
| 10 | Tail gas stream |
| 14 | ammonia/oxygen-enriched air mixture |
| 15 | NOₓ gas/steam mixture |
| 17 | aqueous diluted nitric acid mixture |
| 22 | gaseous NOₓ stream |
| 27 | stream of raw nitric acid containing residual NOₓ gas |
| 32 | ammonia |
| 34 | pressurized air |
| 35 | mixing apparatus |
| 36 | air compressor |
| 37 | ammonia converter operable at a pressure P1 |
| 38 | gas cooler/condenser |
| 39 | cooler/separator |
| 41 | absorption tower |
| 43 | tail gas heater |
| 50 | oxygen-rich gas |
| 51 | steam turbine |
| 52 | first tail gas stream |
| 53 | means for pressurizing the tail gas stream directed to means for |
| | pressurizing 53 |
| 55 | means for splitting the tail gas |
| 56 | First oxygen-containing gas |
| 57 | bleacher |
| 58 | bleacher inlet for bleaching gas 60 |
| 59 | bleacher outlet for bleached nitric acid 63 |
| 60 | oxygen-rich gas bleaching gas |
| 61 | bleaching gases or off-gases out of the bleacher 57 from the |
| | bleacher outlet 65 |
| 63 | bleached nitric acid |
| 64 | bleacher inlet for raw nitric acid containing residual NOₓ gas 27 |
| 65 | bleacher outlet for bleaching gases 61 |
| 66 | pressurized water electrolyzer |
| 67 | Second oxygen-containing gas |
| 70 | expanded tail gas |
| 71 | De-NOₓ treatment unit |
| 73 | heat exchanger |
| 74 | second tail gas stream |
| 76 | tail gas stream partly substituting a source of secondary air |

### DETAILED DESCRIPTION

Throughout the description and claims of this specification, the words “comprise” and variations thereof mean “including but not limited to”, and they are not intended to (and do not) exclude other moieties, additives, components, integers or steps. Throughout the description and claims of this disclosure, the singular encompasses the plural unless the context otherwise requires. In particular, where the indefinite article is used, the disclosure is to be understood as contemplating plurality as well as singularity, unless the context requires otherwise.

Features, integers, characteristics, compounds, chemical moieties, or groups described in conjunction with a particular aspect, embodiment or example of the disclosure are to be understood to be applicable to any other aspect, embodiment or example described herein unless incompatible therewith. All of the features disclosed in this disclosure (including the description, claims, abstract and drawing), and/or all of the steps of any method or process so disclosed, may be combined in any combination, except combinations where at least some of such features and/or steps are mutually exclusive. The disclosure is not restricted to the details of any foregoing embodiments. The disclosure extends to any novel one, or any novel combination, of the features disclosed in this disclosure (including the description, claims, abstract and drawing), or to any novel one, or any novel combination, of the steps of any method or process so disclosed.

The enumeration of numeric values by means of ranges of figures comprises all values and fractions in these ranges, as well as the cited end points. The terms “ranging from . . . to . . . ” or “range from . . . to . . . ” or “up to” as used when referring to a range for a measurable value, such as a parameter, an amount, a time period, and the like, is intended to include the limits associated to the range that is disclosed.

Where the term “about” when applied to a particular value or to a range, the value or range is interpreted as being as accurate as the method used to measure it.

As defined herein, a pressurized oxygen-rich gas is a gas having a pressure ranging from 9 to 30 bara, preferably 15 to 30 bara, and comprising more than 21 vol % of oxygen, more in particular more than 30 vol %, more than 40 vol %, more than 50 vol %, more than 60 vol %, more than 70 vol %, more than 80 vol %, more than 90 vol %, more than 95 vol %, and more than 99 vol %, more in particular 100 vol % of oxygen.

As defined herein, an oxygen-rich gas is a gas comprising more than 21 vol % of oxygen, more in particular more than 30 vol %, more than 40 vol %, more than 50 vol %, more than 60 vol %, more than 70 vol %, more than 80 vol %, more than 90 vol %, more than 95 vol %, and more than 99 vol %, more in particular 100 vol % of oxygen. An oxygen-rich gas can, for example, be provided by an air separation unit or by a water electrolyzer.

As defined herein, air is ambient air having atmospheric pressure.

As defined herein, steam are water vapors.

As defined herein, the term “flow” refers to either a volumetric flow or a mass flow.

The present disclosure generally relates to a mono-pressure system and method for the production of nitric acid with important gains compared to conventional systems and methods, wherein the conventional primary air and/or secondary air consisting of pressurized air, provided by an air compressor with a typical capacity of at least 300000 m³/h, is replaced by the combination of (i) oxygen gas or an oxygen-rich gas, in particular a pressurized oxygen gas or oxygen-rich gas, such as produced by a high-pressure water electrolyzer as further discussed herein; and (ii) a recirculated tail gas stream, thus removing the need for an air compressor to generate compressed primary and/or secondary air. Stated differently, in the system and methods for the production of nitric acid according to the present disclosure:
(i) oxygen gas or an oxygen-rich gas, in particular a pressurized oxygen gas or oxygen-rich gas, such as produced by a high-pressure water electrolyzer, is used (a) upon mixing with part of the tail gas stream, to provide a first oxygen-containing gas stream, which is mixed with an ammonia gas stream and subsequently provided to the ammonia converter, and (b) is used to provide a second oxygen-containing gas stream downstream of the ammonia convertor, such as a second oxygen-containing gas stream which is mixed with a NOx containing gas stream downstream of the ammonia convertor, such as in an oxidation section and/or upstream of the absorber, and/or which is used as a stripping gas in a bleacher, wherein, in particular, the oxygen containing bleacher off-gases are subsequently mixed with a NOx containing gas stream downstream of the ammonia convertor and upstream of the absorber; and
(ii) the tail gas exiting the absorber is split in a first tail gas stream and a second tail gas stream, wherein the first tail gas stream is mixed with the oxygen gas or the oxygen-rich gas, in particular the pressurized oxygen gas or oxygen-rich gas, such as produced by a high-pressure water electrolyzer, to provide the first oxygen-containing gas stream; and/or wherein part of the tail gas exiting the absorber may also be mixed with the oxygen gas or oxygen-rich gas, or the first oxygen containing gas, in particular the pressurized oxygen gas or oxygen-rich gas, such as produced by a high-pressure water electrolyzer, to provide the second oxygen-containing gas stream.

### Nitric Acid Production Plant

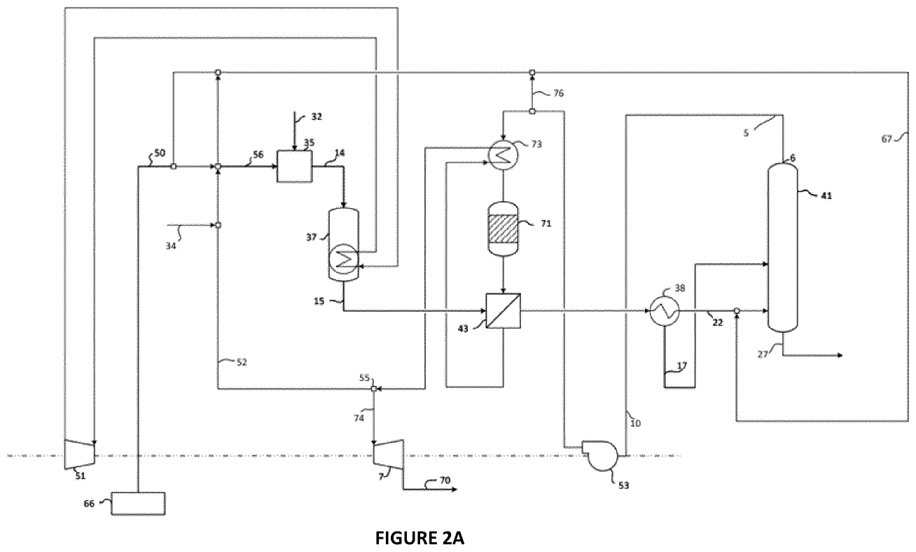

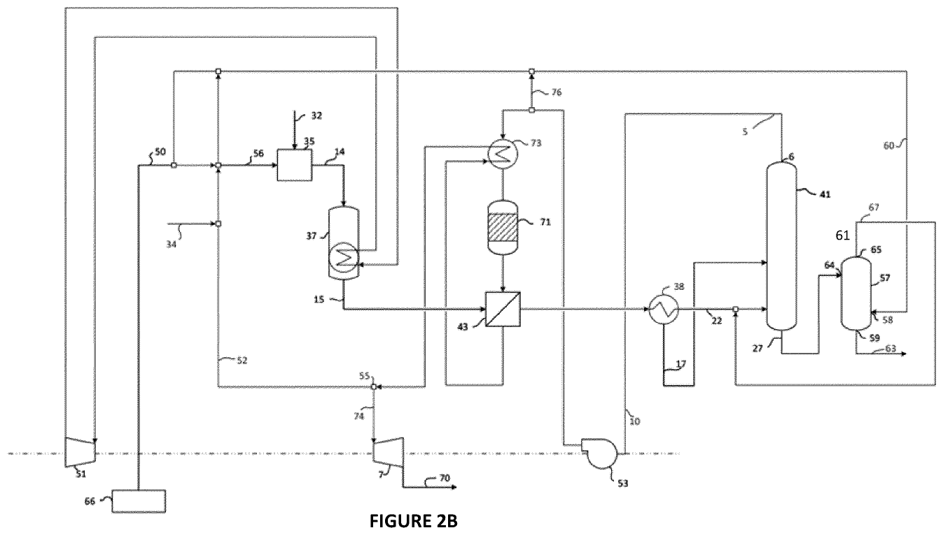

Reference is made to FIGS. 2A and 2B. In one aspect of the disclosure a production plant for producing nitric at reduced power consumption and reduced emissions, is disclosed. The production plant comprises:
preferably, a source of pressurized air 34, particularly for pressurizing the production plant or system during start-up, which is in fluid communication with a system comprising a source or supply of an oxygen-rich gas 50. As defined herein, a source of pressurized air is capable of providing from 2000 to 19000 m³/h of pressurized air;
a mixing apparatus 35 downstream the source or supply of the first oxygen-rich gas 50, for mixing a first oxygen-containing gas 56, particularly having a pressure P1, with an ammonia gas stream 32, to produce an ammonia/oxygen-containing gas mixture 14;
preferably, a means for measuring the oxygen concentration in the first oxygen-containing gas 56;
preferably, a means for adjusting the concentration of oxygen in the first oxygen-containing gas 56 such that the oxygen to ammonia molar ratio at the inlet of the ammonia converter 37 is at least 1.2 or 1.25 and, preferably, a means for adjusting the supply of the ammonia gas stream 32 to the mixing apparatus 35. The system according to the present disclosure may thus comprise a means for regulating (not shown) the concentration of ammonia and/or of oxygen in the ammonia converter 37, particularly a means for controlling the flow of the oxygen-rich gas 50 and/or a means for controlling the flow of the ammonia gas stream 32, for maintaining the oxygen to ammonia molar ratio inside the ammonia converter 37 at a ratio of at least 1.20, such as between 1.20 and 9, between 1.25 and 9 or between 1.3 and 9;
an ammonia converter 37 operable at a pressure P1, wherein pressure P1 is in particular equal to or lower than the pressure of the source of oxygen-rich gas 50, for oxidising ammonia in the ammonia/oxygen-containing gas mixture 14, to produce a NOₓ gas/steam mixture 15, comprising water and nitric oxide;
preferably, means for measuring the temperature in the ammonia converter 37;
a gas cooler/condenser 38 downstream the ammonia converter 37, to produce an aqueous diluted nitric acid mixture 17 and a gaseous NOₓ stream 22;
an absorption tower 41, downstream the gas cooler/condenser 38, for absorbing the NOₓ gases from the gaseous NOₓ stream 22 in water, to produce a stream of raw nitric acid containing residual NOₓ gas 27 and a tail gas 5 comprising NOₓ gases, said absorption tower comprising an absorption tower tail gas outlet 6 for evacuating the tail gas 5;
preferably, a means for measuring the concentration of oxygen in a tail gas stream downstream the absorption tower 41;
a source or supply for a second oxygen containing gas or a second oxygen-rich gas 60, 61, 67, for supplying oxygen between the ammonia converter 37 and the absorption tower 41, particularly to a NOx gas containing stream between the ammonia converter 37 and the absorption tower 41, such that the tail gas 5 contains at least 0.5% by volume oxygen; and
a tail gas heater 43, positioned upstream from the gas cooler/condenser 38, for heating a tail gas stream, such as the tail gas 5 coming from the absorption tower 41 to a temperature ranging up to 650° C. with the heat from the NOₓ gas/steam mixture 15 coming from the ammonia converter 37.

The production plant or system according to the present disclosure is characterized in that the system further comprises:
a means for splitting 55 a stream of tail gas (downstream the absorption tower 41) into a first tail gas stream 52, which is in fluid communication with the oxygen-rich gas 50, and a second tail gas stream 74, particularly wherein the mixing of the oxygen-rich gas 50 and the first tail gas stream 52 provides the first oxygen-containing gas 56;
a means for pressurizing 53 a gas to a pressure P1, particularly to provide the first tail gas stream at a pressure P1, located anywhere downstream the absorption tower 41, such as between the absorption tower 41 and the mixing apparatus 35, or anywhere between the ammonia converter 37 and the absorption tower 41, or upstream the ammonia converter 37 in the oxygen-containing stream 56 or in the ammonia/oxygen-containing gas mixture 14; and
preferably, a means for adjusting the amount of tail gas being split into the first tail gas stream 52 and the second tail gas stream 74.

As defined herein a tail gas heater is a heat exchange system comprising one or more heat exchanger units. In the case the heat exchanger is made of multiple heat exchanger units, the person skilled in the art will realize that it is possible to split the stream of tail gas downstream the absorption tower 41 inside the tail gas heater 43.

As defined herein, a stream of tail gas, also referred to as a tail gas stream, is any gas stream downstream the absorption tower, such as located between the absorption tower 41 and the point of communication or mixing between the first tail gas stream 52 and the oxygen-rich gas 50.

As defined herein, a means for splitting is any means suitable for splitting a tail gas stream, particularly a tail gas stream downstream the absorption tower 41, such as to generate a first tail gas stream 52, and a second tail gas stream 74. In particular, the means for splitting is a T-connection having one inlet and two outlets, such that a gas flowing through the inlet of the T-connection is split into two gas streams of identical chemical composition.

As defined herein, a means for pressurizing is any suitable means for increasing the pressure of a gas stream. In particular, the means for pressurizing is a gas compressor or a gas ejector.

The person skilled in the art will realize that the means for splitting can be incorporated inside the means for pressurizing, provided that the means for pressurizing includes at least two outlets for the gas stream being pressurized.

As defined herein, a means for adjusting the amount of tail gas stream being split into the first tail gas stream 52 and the second tail gas stream 74 are any means for controlling the splitting in the means for splitting 55. In particular, the means for splitting 55 is a T-connection as described above and the means for adjusting is an orifice or a guide vane or a flow control valve at one or both of the outlets of the T-connection.

Even more in particular, the means is an integrated process control system, in which the temperature in the ammonia converter 37 is determined through the means for measuring the temperature. The temperature in the ammonia converter 37 is then used for controlling a flow control means in the means for splitting 55, thereby controlling the splitting of the tail gas 5, in order for the measured temperature to be maintained in the range of 800-950° C.

As defined herein, a means for adjusting the oxygen concentration are any suitable means for regulating the amount of oxygen to be introduced in the system from a measurement of the oxygen concentration. The oxygen concentration can be determined, for example, from a measurement in the gas phase using a process gas analyzer. The oxygen concentration can also be determined from computing using the concentration of the oxygen source being introduced in the system, in particular the oxygen concentration of the oxygen-rich gas 50, the flow at which the oxygen source, in particular the oxygen-rich gas, is introduced in the system, preferably the flow at which the ammonia gas stream is introduced in the system, and the relative flow values of the gases with which the oxygen source is mixed, in particular the relative flow values at which the oxygen-rich gas 50 and the ammonia gas stream are mixed. Using the oxygen concentration, the relevant flow of oxygen to be introduced in the system is, in turn, determined and is used in controlling the flow of oxygen, from a gaseous source of oxygen at a pre-determined concentration. Controlling of the flow of gaseous oxygen can, for example, be achieved through flow control valves. In this context, as defined herein, a means for regulating the concentration of ammonia and/or of oxygen is any means suitable for achieving a target concentration of ammonia and/or of oxygen. In particular, such means are gas flow control means, in particular a flow control valve or an orifice or a guide vane, for controlling the flow of the oxygen-rich gas 50 and/or of the ammonia gas stream 32. In particular, the means is an integrated process control system, in which the concentration of oxygen is measured, and the relevant flow of oxygen is thereby determined and achieved from controlling the flow of the first oxygen rich gas, from a gaseous source of oxygen at a pre-determined concentration.

Typically, P1 ranges from 2 to 16 bara. The person skilled in the art will determine the optimal concentration of oxygen in the gases entering the ammonia converter 37 and the absorption tower 41, in order for the catalytic conversion of ammonia to nitric oxide to proceed optimally in the ammonia converter 37 and for the absorption of NOₓ gases in the absorption tower 41 to proceed optimally. Further, upon determining the oxygen content exiting the absorption tower 41, the skilled person will also weigh out the benefits of increasing the oxygen content in the absorption tower 41, in particular a reduced tower size due to improved absorption, against the drawback of a higher gas volume downstream the absorption tower 41 implying equipment, such as heat exchangers, of a larger size, for heating tail gas.

As defined herein, means for measuring the temperature are any means suitable for measuring and indicating the temperature in the ammonia oxidation burner. In particular, the means for measuring the temperature is a thermocouple or a thermocouple or a thermometer suitable for measuring and indicating a temperature as high as 1000° C. More in particular, the means for measuring the temperature is an infrared thermometer for measuring and indicating a temperature as high as 1000° C.

As defined herein, means for converting steam into power are any means for achieving power from steam. In particular, those means are a steam turbine connected to an electric generator.

Considering that a production cycle of a unit or plant comprises (a) a start-up phase, wherein the different processes are initiated, (b) a continuous and essentially constant phase or operation mode, wherein processes operate at a given working load that is usually kept constant during a production cycle; and (c) a shutdown phase, where processes are slowly and safely stopped, the term “during operation” or “during continuous operation” of a unit or plant, in particular of nitric acid plant, refers to the continuous operation mode wherein the unit or plant produces a product, in particular nitric acid.

The inventors have found that, instead of continuously supplying pressurized air 34 provided by an air compressor 36 to the mixing unit 35 at a pressure P1, in particular during continuous operation of the nitric acid plant, it is possible to recirculate the first tail gas stream 52 at a pressure P1. Therefore, compressed or pressurized air only has to be supplied in order to start the process, i.e. during the start-up phase of the nitric acid plant, in particular to pressurize the system, but no longer after the production of the tail gas has started, during the continuous operation phase or mode, and an air compressor 36 is not required. Due to pressure drop in the gas stream in its trajectory from the ammonia converter 37 to the outlet 6 of the absorption tower 41, the tail gas 5 has a pressure lower than P1 and, therefore, the means for pressurizing 53 provides a pressure P1 to the tail gas stream 10. In addition, the oxygen-rich gas 50 having a pressure P1 and the supply for an oxygen-rich gas 67 provide oxygen to the ammonia converter 37 and to the absorption tower 41, respectively, such that, in the absence of the primary and secondary air provided by the air compressor 36, the concentration of oxygen in the ammonia converter 37 and in the absorption tower 41 is similar to and can be controlled to that in a standard mono pressure nitric acid plant.

In the absence of an air compressor 36 and with the tail gas stream 52 being recirculated in the system, not only is the power demand of the system reduced: the NOₓ emissions leaving the system are also reduced. Therefore, the size of the treatment unit for treating those NOₓ emissions is reduced with respect to the size in the corresponding standard mono pressure nitric acid plant.

In one embodiment according to the production plant of the disclosure, the system further comprises one or more of:
a heat exchanger 73, for exchanging heat between the tail gas 5 and the stream of tail gas exiting the heater 43, wherein the stream of tail gas having exchanged heat with the tail gas 5 is split in the means for splitting 55 downstream the heat exchanger 73 and wherein the means for pressurizing 53 are located upstream the heat exchanger 73. Stated differently, the system comprises a heat exchanger 73, for exchanging heat between a heated tail gas stream downstream the tail gas heater 43 and a tail gas stream upstream the tail gas heater 43, wherein the heated tail gas stream downstream the tail gas heater 43 and having exchanged heat with the tail gas stream upstream the tail gas heater 43 is in direct fluid communication with the means for splitting 55;
a De-NOₓ treatment unit 71; and
a steam turbine 51, wherein the steam turbine can at least partly power the means for pressurizing 53.

Advantageously, the means for splitting 55 is located downstream the tail gas heater 43. Indeed, both the first tail gas stream 52 and the second tail gas stream 74 are then at an optimal temperature. In particular, this means that the first stream of tail gas 52 is at a temperature below 300° C., such that the first tail gas stream 52 can be fed to the ammonia converter 37 without the amount of ammonia fed through the stream 32, having to be adjusted in order to maintain the temperature ranging from 800 to 950° C. in the ammonia converter 37, the temperature at which the ammonia converter 37 is operable. In addition, the location of the means for splitting 55 at this location confers to the second tail gas stream 74 an optimal temperature for being expanded in the tail gas expander 7 such as to provide an optimal of energy which can be used to power the means for pressurizing 53. Further, the presence of a steam turbine 51 allows for the recovery of the heat of the steam produced in the ammonia converter 37 and this recovered heat can be used, at least partly, for powering the means for pressurizing 53. Finally, the use of the steam turbine 51 and the location of the means for pressurizing upstream the heat exchanger 73 contribute to operating the production plant in an energy-efficient manner. Indeed, less power is required for the means for pressurizing 53 to pressurize a stream of tail gas before it is heated by the heat exchanger 73.

In particular, the tail gas 5 is heated in the heat exchanger 73 from a temperature ranging from 20 to 250° C., to a temperature ranging from 100 to 450° C. Subsequently, the tail gas exiting the heat exchanger 73 is heated in the tail gas heater 43 to a temperature ranging from 200 to 550° C. The tail gas exiting the heat exchanger 73 then is at an optimal temperature for being treated in the De-NOₓ treatment unit 71 and, therefore, the De-NOₓ treatment unit 71 is located between the heat exchanger 73 and the tail gas heater 43. The person skilled in the art will, without any difficulty, select the proper location for the De-NOₓ treatment unit 71 such that the operating temperature of the De-NOₓ treatment unit 71 is in agreement with the temperature of the corresponding stream of tail gas.

In one embodiment according to the production plant of the disclosure, the production plant further comprises a bleacher 57 comprising an inlet 58 for an oxygen-rich bleaching gas 60 and an outlet for bleaching gases or off-gases 61. It is understood that the bleacher further comprises an inlet 64 for the stream of raw nitric acid containing residual NOₓ gas 27 and an outlet 59 for bleached nitric acid 63. The bleaching gases or off-gases 61 are in fluid communication with any gas stream between the ammonia converter 37 and the absorption tower 41, such that the supply for or source of an oxygen-rich gas, in particular the second oxygen-containing gas 60, 61, 67 is at least partly provided by the bleaching gases or off-gases 61.

The person skilled in the art will understand that the pressure of the bleaching gases or off-gases 61 is to be adjusted to about P1 before joining the gaseous NOₓ stream 22. When the stream of raw nitric acid containing residual NOₓ gas 27 is bleached, the amounts of NOₓ gases and nitrous acid HNO₂ in the nitric acid solution are reduced. This in turn results in less brown fumes coming out of the nitric acid solution. In addition, the nitric acid solution provided by the bleacher is of a higher quality, that is purer.

Conveniently, when the stream of raw nitric acid containing residual NOₓ gas 27 is bleached, the bleaching gases or off-gases 61 is the oxygen-rich gas supplied by the corresponding source 67: the supply of the oxygen-rich gas 67, in particular the second oxygen-containing gas, is achieved through the bleacher 57 and no separate source of oxygen is required.

In one embodiment according to the production plant of the disclosure, part of the oxygen-rich gas 50 or part of the first oxygen-containing gas 56 or part of the tail gas 5, such as part of a tail gas stream 76, is in fluid communication with the inlet 58 of the bleacher 57, such that the oxygen-rich bleaching gas or stripping gas 60 is at least partly provided by part of the oxygen-rich gas 50 or part of the first oxygen-containing gas 56 or part of the tail gas 5, such as part of a tail gas stream 76, downstream the means for pressurizing 53.

If a bleacher 57 is present, as no secondary air is fed by an air compressor (36 in the standard nitric acid plant) to the bleacher 57, the bleacher can be conveniently fed by the oxygen-rich gas 50. Also, once tail gas 5 is produced and recirculated, part of the oxygen-containing gas 56 or part of the tail gas 5 can be fed to the bleacher 57: the concentration of NOₓ gases in the oxygen-containing gas 56 or in the tail gas 5 is sufficiently low that the bleaching in the bleacher 57 remains sufficiently efficient. As the means for pressurizing 53 is located in a tail gas stream, downstream the absorption tower 41, it is ensured that the oxygen-rich bleaching gas 60 has a pressure about P1.

In one embodiment according to the production plant of the disclosure, the oxygen-rich gas 50, the supply for the oxygen-rich gas 67, in particular the second oxygen-containing gas 60, 61, 67, the oxygen-rich bleaching gas 60, and the oxygen-rich off-gases 61 are all provided at least partly by a water electrolyzer 66.

A water electrolyzer is a device for the electrolysis of water, being the decomposition of water into oxygen and hydrogen gas, due to the passage of an electric current therethrough. This technique can be used to make hydrogen gas, a main component of hydrogen fuel, and oxygen gas. A suitable high-pressure water electrolyzer may comprise an anode producing oxygen gas according to the reaction

$$\\ 2 OH ‐ = {H}_{2} O + 1 / 2 {O}_{2} + 2 e ‐ ;$$

a cathode, producing hydrogen gas according to the reaction

$$\\ 2 {H}_{2} O + 2 e ‐ = {H}_{2} + 2 OH ‐ ;$$

an electrolyte consisting of an alkaline solution such as potassium hydroxide; and a porous diaphragm separating the anode and the cathode, in order to avoid the mixing of hydrogen gas and oxygen gas that together form an explosive mixture. Alternatively, the anode and the cathode may be separated by a solid polymer electrolyte such as the fluoropolymer Nafion, where the electrolyte provides the selective transport of protons from the anode to the cathode, as well as the electrical insulation between the anode and the cathode, and avoids the mixing of hydrogen gas and oxygen gas that together form an explosive mixture.

The anode and cathode can be made of nickel or steel, or mixtures thereof. Alternatively, for the purpose of enhancing the electrode reactions, the anode and cathode may contain catalysts that can be made of Iridium and Platinum, respectively. The diaphragm of an electrically insulating material is based on, for example, zirconia. The diaphragm has a porosity such that it forms a barrier against transport of hydrogen and oxygen gas bubbles, while containing a continuum of penetrated liquid electrolyte. An anode-diaphragm-cathode assembly constitutes an electrolysis cell. Electrolysis cells are piled in series in stacks that compose the core of an electrolyzer. The hydrogen and oxygen production for a given stack volume is proportional to the current density and inversely proportional to the stacking distance. Regardless of stack volume, the hydrogen and oxygen production is proportional to the total current. In addition to the stack, the electrolyzer comprises auxiliaries such as a current rectifier, a water demineralization unit, a water pump and a cooling system, a hydrogen purification unit, and instrumentation.

The electrolyzer is operated by applying a voltage corresponding to the standard potential plus the overpotential over each cell. The total voltage depends on the total number of cells of which the electrolyzer is comprised. OH— ions generated at the cathode migrate through the electrolyte in the diaphragm to the anode, where they are consumed by the anode reaction. Electrons travel the opposite direction in an external circuit. The electrolyzer may be operated at a temperature of 50 to 80° C., or 60 to 80° C., and a gas pressure of 2 bara, preferably, as a high-pressure water electrolyzer at a pressure of 9 to 30 bara, even more preferably 15 to 30 bara.

A high-pressure water electrolyzer hence results in the production of pressurized hydrogen at the cathode and pressurized oxygen at the anode, such as having a pressure of 9 to 30 bara, even more preferably 15 to 30 bara. What is required to perform high-pressure electrolysis is to pressurize the water used in the electrolysis process. As pressurizing water requires less power than pressuring a gas, the use of a high-pressure water electrolyzer results in the production of pressurized oxygen-rich gas at minimized power consumption.

Conveniently, the water electrolyzer 66 provides oxygen to all the various points where oxygen needs to be fed. In particular, the supply of oxygen from the electrolyzer 63 is sufficient to provide all of the oxygen of the first oxygen-rich gas 50, the second oxygen-containing gas 60, 61, 67, the oxygen-rich bleaching gas 60 and the off-gases 61. In this manner, the system is simplified and can comprise a single source of oxygen from which oxygen-containing gas streams can be produced. In particular, oxygen-containing streams can be produced at the desired pressure, using standard pressure adjustment means. The use of a high-pressure electrolyzer operable at 9 to 30 bara, even more preferably 15 to 30 bara, is particularly useful as a source of oxygen gas to be supplied to a bleacher operating at a pressure higher than P1. In addition, as less energy is required to pressurize water than to pressurize oxygen gas, pressurized oxygen gas is obtained at minimum power consumption.

Another advantage of the presence of a high-pressure water electrolyzer lies in the potential to, in parallel to producing oxygen gas that can be used in nitric acid production, also produce hydrogen gas. Such hydrogen gas is produced in a green manner, that is without the conventional use of natural gas which results in the production of the green-house gas carbon dioxide, CO₂. The hydrogen gas can then be used in the production of ammonia in a Haber-Bosch or also conventionally named synthesis gas unit. The high-pressure water electrolyzer then enables the integration of the ammonia and nitric acid production processes.

In one embodiment according to the production plant of the disclosure, the production plant further comprises a tail gas expander 7 for expanding the second tail gas stream 74 to atmospheric pressure, to produce an expanded tail gas 70, wherein the means for pressurizing 53 can be powered at least partly by the tail gas expander 7 or by the steam turbine 51 or by a power source.

In the presence of such tail gas expander 7, the second tail gas stream 74 can be expanded, thereby providing power that can be used for powering the means for pressurizing 53.

In one embodiment according to the production plant of the disclosure, the fluid communication between the source of pressurized air 34, for pressurizing the system during the startup phase, and the system is in direct fluid communication with the oxygen-rich gas 50. It is preferred to introduce pressurized air 34 through a direct fluid communication with the oxygen-rich gas 50. In this manner, upon operating the means for pressurizing during the start-up of the system, it is ensured that air flows through the ammonia converter 37 when ammonia 32 is being fed to ammonia converter 37, such that there is a sufficient concentration of oxygen to convert ammonia into nitric oxide. Subsequently, the nitric acid process being induced, tail gas 5 and the first tail gas stream 52 can be produced and recirculated to the mixing unit 35, upon feeding the oxygen-rich gas 50.

### Method for Producing Nitric Acid

Reference is made to FIGS. 2A and 2B. In one aspect of the disclosure, a method for producing nitric acid at reduced power consumption and reduced emissions, in a production plant according to the production plant of the disclosure, is disclosed. The method comprises the steps of
a) preferably, pressurizing the system to a pressure of P1, by supplying pressurized air having a pressure P1 34 in the system;
b) preferably, inducing a pressurized air flow in the system by operating the means for pressurizing 53 using external power;
c) supplying the ammonia gas stream 32 to the mixing apparatus 35, thereby producing the ammonia/oxygen-containing gas mixture 14;
d) oxidising ammonia in the ammonia/oxygen-containing gas mixture 14 in the ammonia converter 37 at a pressure equal to or lower than P1, preferably at a pressure P1, and, particularly, at a temperature ranging from 800 to 950° C., thereby producing the gaseous NOₓ gas/steam mixture 15, comprising water and nitric oxide;
e) separating and condensing steam in the gas cooler/condenser 38, thereby generating the aqueous diluted nitric acid mixture 17 and the gaseous NOₓ stream 22;
f) absorbing the gaseous NOₓ stream 22 in the absorption tower 41, thereby producing the stream of raw nitric acid 27 containing residual NOₓ gas and the tail gas 5 comprising NOₓ gases; and
g) heating the tail gas 5 in the tail gas heater 43, particularly to a temperature ranging up to 650° C. with the gaseous NOₓ gas/steam mixture 15;

The method is characterized in that it further comprises the steps of
h) pressurizing a gas stream located anywhere downstream the absorption tower 41, or anywhere between the ammonia converter 37 and the absorption tower 41, or upstream the ammonia converter 37 in the first oxygen-containing stream 56 or in the ammonia/oxygen-containing gas mixture 14, with the means for pressurizing 53;
i) in particular, splitting a tail gas stream with the means for splitting 55 into the first tail gas stream 52 and the second tail gas stream 74; and mixing the first tail gas stream 52 with the oxygen-rich gas 50, thereby providing the first oxygen-containing gas 56;
j) optionally, measuring the oxygen concentration in the first oxygen-containing gas 56;
k) adjusting the supply or flow of the oxygen-rich gas 50 being mixed in step i) or the supply or flow of the ammonia gas stream 32 in step c), such that the oxygen to ammonia molar ratio at the inlet of the ammonia converter 37 is at least 1.20 or 1.25, or such as to maintain the oxygen to ammonia molar ratio inside the ammonia converter 37 at a ratio of at least 1.2 or 1.25, such as ranging from 1.2 to 9, or 1.25 to 9 or from 1.3 to 9, particularly in case the oxygen concentration measured in step j) is such that the oxygen to ammonia molar ratio at the inlet of the ammonia converter 37 less than 1.2;
l) optionally, measuring the temperature in the ammonia converter 37;
m) optionally, adjusting the volume of the first tail gas stream 52 being mixed in step i) or the supply of the ammonia gas stream 32 supplied in step c), if the temperature measured in step l) is outside the range of 800-950° C., such that the temperature in the ammonia converter is maintained in the range of 800-950° C.;
n) optionally, measuring the oxygen concentration in a tail gas stream downstream the absorption tower 41;
o) adjusting the supply or flow of the oxygen-rich gas 67, in particular the flow of the second oxygen-containing gas 60, 61, 67, in particular between the ammonia converter 37 and the absorption tower 41, such that the tail gas 5, in particular a tail gas stream 5, 52, 70, 74, 76, contains at least 0.5% by volume oxygen, in particular in case the oxygen concentration measured in step n) is less than 0.5% by volume oxygen;
p) supplying the first oxygen-containing gas 56 to the mixing unit 35; and
q) in particular, repeating steps c) to p).

Typically, P1 ranges from 2 to 16 bara. The person skilled in the art will determine the optimal percentages of oxygen in the gases entering the ammonia converter 37 and the absorption tower 41, in order for the catalytic conversion of ammonia to nitric oxide to proceed optimally in the ammonia converter 37 and for the absorption of NOₓ gases in the absorption tower 41 to proceed optimally. Further, upon determining the oxygen content exiting the absorption tower 41, he will establish weigh out the benefits of increasing the oxygen content in the absorption tower 41, against the drawback of a higher gas volume downstream the absorption tower 41 implying equipment, such as heat exchangers, of a larger size, for heating tail gas.

The inventors have found that, instead of continuously supplying pressurized air 34 provided by an air compressor 36 to the mixing unit 35 at a pressure P1, in particular during continuous operation of the nitric acid plant, it is possible to recirculate the first tail gas stream 52 at a pressure P1. Therefore, compressed or pressurized air only has to be supplied in order to start the process, i.e. during the start-up phase of the nitric acid plant, for pressurizing the system, but no longer after the production of the tail gas has started, during the continuous operation phase or mode, and an air compressor 36 is not required. Due to pressure drop in the gas stream in its trajectory from the ammonia converter 37 to the outlet 6 of the absorption tower 41, the tail gas 5 has a pressure lower than P1 and, therefore, the means for pressurizing 53 provides a pressure P1 to a tail gas stream 10, and thus to the first tail gas stream 52. In addition, the oxygen-rich gas 50 having a pressure P1 and the supply for an oxygen-rich gas 67 respectively provide oxygen to the ammonia converter 37 and to the absorption tower 41, such that, in the absence of the primary and secondary air provided by the air compressor 36, the concentration of oxygen in the ammonia converter 37 and in the absorption tower 41 is similar to and can be controlled to that in a standard mono pressure nitric acid plant.

In the absence of an air compressor 36 and with the tail gas stream 52 being recirculated in the system, not only is the power demand of the system reduced: the NOₓ emissions leaving the system are also reduced. Therefore, the size of the treatment unit for treating those NOₓ emissions is reduced with respect to the size in the corresponding standard mono pressure nitric acid plant.

In one embodiment according to the method of the disclosure, in step h), at least part of the tail gas obtained from step f) is pressurized in the means for pressurizing 53, in particular thereby generating a pressurized tail gas; more in particular wherein step h) is performed before step i), and wherein the method further comprises the steps of
h1) after step f) or g) and before step g) or h), respectively, heating the tail gas 5 with the tail gas to be mixed in step i), in the heat exchanger 73, thereby bringing the tail gas to be mixed in step i) to a temperature below 300° C., in particular heating the pressurized tail gas in the heat exchanger 73 with a tail gas stream downstream the tail gas heater 43 and to be split in step i) to a temperature below 300° C.;
r) treating the tail gas 5, particularly treating the heated tail gas from step h1), in the De-NOₓ treatment unit 71, in particular before step g) and after step h1); and
s) recovering at least part of the steam generated in the ammonia converter 37 in the steam turbine 51.

Advantageously, the means for splitting 55 is located downstream the tail gas heater 43. Indeed, both the first tail gas stream 52 and the second tail gas stream 52 are then at an optimal temperature. This means that the first tail gas stream 52 is at a temperature below 300° C., such that the first tail gas stream 52 can be fed to the ammonia converter 37 without the amount of ammonia fed through the stream 32, having to be adjusted in order to maintain the temperature ranging from 800 to 950° C. and at which the ammonia 37 is operable, in the ammonia converter 37. In addition, the location of the means for splitting 55 at this location confers to the second tail gas stream 74 an optimal temperature for being expanded in the tail gas expander 7 such as to provide an optimal of energy which can be used to power the means for pressurizing 53. Further, the presence of a steam turbine 51 allows for the recovery of the heat of the steam produced in the ammonia converter 37 and this recovered heat can be used, at least partly, for powering the means for pressurizing 53. Finally, the use of the steam turbine 51 and the location of the means for pressurizing upstream the heat exchanger 73 contribute to operating the production plant in an energy-efficient manner. Indeed, less power is required for the means for pressurizing 53 to pressurize a tail gas stream before it is heated by the heat exchanger 73.

In particular, the tail gas 5 is heated in the heat exchanger 73 from a temperature ranging from 20 to 250° C., to a temperature ranging from 100 to 450° C. Subsequently, the tail gas exiting the heat exchanger 73 is heated in the tail gas heater 43 to a temperature ranging from 200 to 550° C. The tail gas exiting the heat exchanger 73 then is at an optimal temperature for being treated in the De-NOₓ treatment unit 71 and, therefore, the De-NOₓ treatment unit 71 is located between the heat exchanger 73 and the tail gas heater 43. The person skilled in the art will, without any difficulty, select the proper location for the De-NOₓ treatment unit 71 such that the operating temperature of the De-NOₓ treatment unit 71 is in agreement with the temperature of the corresponding tail gas stream.

In one embodiment according to the method of the disclosure, the method further comprises the step of t) bleaching the stream of raw nitric acid 27 containing residual NOₓ gas in the bleacher 57, thereby producing the bleached nitric acid 63.

The person skilled in the art will understand that the pressure of the bleaching gases or off-gases 61 is to be adjusted to about P1 before joining the gaseous NOₓ stream 22. When the stream of raw nitric acid containing residual NOₓ gas 27 is bleached, the amounts of NOₓ gases and nitrous acid HNO₂ in the nitric acid solution are reduced. This in turn results in less brown fumes coming out of the nitric acid solution. In addition, the nitric acid solution provided by the bleacher is of a higher quality, that is purer.

Conveniently, when the stream of raw nitric acid containing residual NOₓ gas 27 is bleached, the bleaching gases or off-gases 61 is the oxygen-rich gas supplied by the corresponding source 67: the supply of the oxygen-rich gas 67 is achieved through the bleacher 57 and no separate source of oxygen is required. In one embodiment according to the method of the disclosure, the method further comprises the step of u) supplying part of the oxygen-rich gas 50 or part of the first oxygen-containing gas 56 obtained in step i) or part of a tail gas stream obtained in step g), to the inlet 58 of the bleacher 57 in step t).

If such bleaching step t) is performed, as no secondary air is fed by an air compressor (36 in the standard nitric acid plant) to the bleacher 57, the bleacher can be conveniently fed by the oxygen-rich gas 50. Also, once the tail gas 5 is produced and recirculated, the oxygen-containing gas 56 or a tail gas stream can also be fed to the bleacher 57: the concentration of NOₓ gases in the oxygen-containing gas 56 or the tail gas 5 is sufficiently low that the bleaching in the bleacher 57 remains sufficiently efficient.

In one embodiment according to the method of the disclosure, the method further comprises the steps of
v) operating the water electrolyzer 66, thereby producing oxygen, in particular operating a high-pressure water electrolyzer, thereby producing pressurized oxygen; and
w) providing, from the oxygen produced by the water electrolyzer 66 in step v), at least (part of) the oxygen-rich gas 50, the supply for an oxygen-rich gas 67, in particular the second oxygen-containing gas 60, 61, 67, and the oxygen-rich bleaching gas 60, and/or the bleaching gases or off-gases 61.

Conveniently, the water electrolyzer 66 provides oxygen to all the various points where oxygen needs to be fed. In particular, the supply of oxygen from the electrolyzer 63 is sufficient to provide all of the oxygen of the first oxygen-rich gas 50, the second oxygen-containing gas 60, 61, 67, the oxygen-rich bleaching gas 60 and the off-gases 61. In this manner, the system is simplified and can comprise a single source of oxygen from which oxygen-containing gas streams can be produced. In particular, oxygen-containing streams can be produced at the desired pressure, using standard pressure adjustment means. The use of a high-pressure electrolyzer operable at 9 to 30 bara, preferably 15 to 30 bara, is particularly useful as a source of oxygen gas to be supplied to a bleacher operating at a pressure higher than P1.

Another advantage of the presence of a high-pressure water electrolyzer lies in the potential to, in parallel to producing oxygen gas that can be used in nitric acid production, also produce hydrogen gas. Such hydrogen gas is produced in a green manner, that is without the conventional use of natural gas which results in the production of the green-house gas carbon dioxide, CO₂. The hydrogen gas can then be used in the production of ammonia in a Haber-Bosch or also conventionally named synthesis gas unit. The high-pressure water electrolyzer then enables the integration of the ammonia and nitric acid production processes.

In one embodiment according to the method of the disclosure, the method further comprises the step of x) expanding the second tail gas stream 74 in the tail gas expander 7 to atmospheric pressure, thereby producing the expanded tail gas 70.

In the presence of such tail gas expander 7, the second tail gas stream 74 can be expanded, thereby providing power that can be used for powering the means for pressurizing 53.

In one embodiment according to the method of the disclosure, in step a), the pressurized air 34 is supplied in the stream in direct fluid communication with the oxygen-rich gas 50.

It is preferred to introduce pressurized air 34 through a direct fluid communication with the oxygen-rich gas 50. In this manner, upon operating the means for pressurizing during the start-up of the system, it is ensured that air flows through the converter 37 when ammonia 32 is being fed to converter 37, such that there is a sufficient concentration of oxygen to convert ammonia into nitric oxide. Subsequently, the nitric acid process being induced, tail gas 5 and the first tail gas stream 52 can be produced and recirculated to the mixing unit 35, upon feeding the oxygen-rich gas 50.

### Use of the Production Plant of the Disclosure

In one aspect of the disclosure, the use of the production plant of the disclosure for performing the method of the disclosure, is disclosed.

### Method for Revamping a Nitric Acid Production Plant

In one aspect of the disclosure, a method for revamping a system, i.e. an existing system, for producing nitric acid into a production plant according to the production plant of the disclosure is disclosed, wherein the system, i.e. the existing system for producing nitric acid, comprises:
an air compressor 36 for providing a compressed air stream 34, in particular having a pressure P1;
a mixing apparatus 35, particularly situated downstream the oxygen-rich gas 50, for mixing the compressed air with an ammonia gas stream 32, to produce an ammonia/oxygen-containing gas mixture 14;
preferably, means for adjusting the supply of the ammonia gas stream 32 to the mixing apparatus 35;
an ammonia converter 37, particularly operable at a pressure P1 equal to or lower than the pressure of the source of oxygen-rich gas 50, for oxidising ammonia in the ammonia/oxygen-containing gas mixture 14, to produce a NOₓ gas/steam mixture 15, comprising water and nitric oxide;
preferably, means for measuring the temperature in the ammonia converter 37;
a gas cooler/condenser 38 downstream the ammonia converter 37, to produce an aqueous diluted nitric acid mixture 17 and a gaseous NOₓ stream 22;
an absorption tower 41, downstream the gas cooler/condenser 38, for absorbing the NOₓ gases from the gaseous NOₓ stream 22 in water, to produce a stream of raw nitric acid 27 containing residual NOₓ gas and a tail gas 5 comprising NOₓ gases, comprising an absorption tower tail gas outlet 6 for evacuating the tail gas 5;
preferably, means for measuring the concentration of oxygen in a tail gas stream downstream the absorption tower 41; and
a tail gas heater 43, positioned upstream from the gas cooler/condenser 38, for heating the tail gas 5 coming from the absorption tower 41 to a temperature up to 650° C. with the heat from the NOₓ gas/steam mixture 15 coming from the ammonia converter 37, in particular for heating a tail gas stream with the heat from the NOx gas/steam mixture 15 coming from the ammonia converter 37.

The revamping method comprises the steps of
optionally, introducing a source of pressurized air, in particular having a pressure P1 34 in fluid communication with the system or production plant, for pressurizing the system or production plant during startup, in particular wherein the source of pressurized air is capable of providing from 2000 to 19000 m³/h of pressurized air;
introducing a source of an oxygen-rich gas 50, providing part of a first oxygen containing gas, upstream the mixing apparatus 35, in particular wherein the mixing of the oxygen-rich gas and the compressed air provides at least part of a first oxygen containing gas 56 during start up;
preferably, introducing means for measuring the oxygen concentration in the first oxygen-containing gas 56;
in particular introducing a supply for a second oxygen-containing gas 60, 61, 67 for supplying oxygen between the ammonia converter 37 and the absorption tower 41, such that a tail gas stream 5, 52, 70, 74, 76 contains at least 0.5% by volume
preferably, introducing means for adjusting the concentration of oxygen in the oxygen-containing gas 56 such that the oxygen to ammonia molar ratio at the inlet of the ammonia converter 37 is at least 1.2 or 1.25. More in particular, there may be introduced a means for regulating (not shown) the concentration of ammonia and/or of oxygen in the ammonia converter 37, particularly a means for controlling the flow of the oxygen-rich gas 50 and/or a means for controlling the flow of the ammonia gas stream 32, for maintaining the oxygen to ammonia molar ratio inside the ammonia converter 37 at a ratio of at least 1.2 or 1.25, such as between 1.2 and 9, between 1.25 and 9 or between 1.3 and 9;
introducing a means for splitting 55 a stream of tail gas downstream the absorption tower 41 into a first tail gas stream 52 and a second tail gas stream 74, wherein the first tail gas stream is in fluid communication with the oxygen-rich gas 50, in particular thereby providing at least part of the first oxygen-containing gas 56,
introducing a means for pressurizing 53 a gas to a pressure P1 anywhere downstream the absorption tower 41, or anywhere between the ammonia converter 37 and the absorption tower 41, or upstream the ammonia converter 37 in the oxygen-containing stream 56 or in the ammonia/oxygen-containing gas mixture 14, such as to provide the first tail gas stream at a pressure P1;
preferably, introducing means for adjusting the amount of tail gas being split into the first tail gas stream 52 and the second tail gas stream 74; and
removing the air compressor 36.

The term “oxygen-rich gas” is used as defined elsewhere herein.

As defined herein a tail gas heater is a heat exchange system comprising one or more heat exchanger units. In the case the heat exchanger is made of multiple heat exchanger units, the person skilled in the art will realize that it is possible to split the stream of tail gas downstream the absorption tower 41 inside the tail gas heater 43.

As defined herein, a stream of tail gas, also referred to as a tail gas stream, is any gas stream downstream the absorption tower, such as located between the absorption tower 41 and the point of communication or mixing between the first tail gas stream 52 and the oxygen-rich gas 50.

As defined herein, a means for splitting is any means suitable for splitting a tail gas stream, particularly a tail gas stream downstream the absorption tower 41, such as to generate a first tail gas stream 52, and a second tail gas stream 74. In particular, the means for splitting is a T-connection having one inlet and two outlets, such that a gas flowing through the inlet of the T-connection is split into two gas streams of identical chemical composition.

As defined herein, a means for pressurizing is any suitable means for increasing the pressure of a gas stream. In particular, the means for pressurizing is a gas compressor or a gas ejector.

The person skilled in the art will realize that the means for splitting can be incorporated inside the means for pressurizing, provided that the means for pressurizing includes at least two outlets for the gas stream being pressurized.

As defined herein, a means for adjusting the amount of tail gas stream being split into the first tail gas stream 52 and the second tail gas stream 74 are any means for controlling the splitting in the means for splitting 55. In particular, the means for splitting 55 is a T-connection as described above and the means for adjusting is an orifice or a guide vane or a flow control valve at one or both of the outlets of the T-connection.

Even more in particular, the means is an integrated process control system, in which the temperature in the ammonia converter 37 is determined through the means for measuring the temperature. The temperature in the ammonia converter 37 is then used for controlling a flow control means in the means for splitting 55, thereby controlling the splitting of the tail gas 5, in order for the measured temperature to be maintained in the range of 800-950° C.

As defined herein, means for adjusting the oxygen concentration are any suitable means for assessing the amount of oxygen to be introduced in the system from a measurement of the oxygen concentration. The oxygen concentration can be determined, for example, from a measurement in the gas phase using a process gas analyzer. The oxygen concentration can also be determined from computing using the concentration of the oxygen source being introduced in the system, in particular the oxygen concentration of the oxygen-rich gas 50, the flow at which the oxygen source, in particular the oxygen-rich gas, is introduced in the system, preferably the flow at which the ammonia gas stream is introduced in the system, and the relative flow values of the gases with which the oxygen source is mixed, in particular the relative flow values at which the oxygen-rich gas 50 and the ammonia gas stream are mixed. Using the oxygen concentration, the relevant flow of oxygen to be introduced in the system is, in turn, determined and is used in controlling the flow of oxygen, from a gaseous source of oxygen at a pre-determined concentration. Controlling of the flow of gaseous oxygen can, for example, be achieved through flow control valves. In this context, as defined herein, a means for regulating the concentration of ammonia and/or of oxygen is any means suitable for achieving a target concentration of ammonia and/or of oxygen. In particular, such means are gas flow control means, in particular a flow control valve or an orifice or a guide vane, for controlling the flow of the oxygen-rich gas 50 and/or of the ammonia gas stream 32. In particular, the means is an integrated process control system, in which the concentration of oxygen is measured, and the relevant flow of oxygen is thereby determined, thus controlling the flow of oxygen, from a gaseous source of oxygen at a pre-determined concentration.

Typically, P1 ranges from 2 to 16 bara. The person skilled in the art will determine the optimal concentration of oxygen in the gases entering the ammonia converter 37 and the absorption tower 41, in order for the catalytic conversion of ammonia to nitric oxide to proceed optimally in the ammonia converter 37 and for the absorption of NOₓ gases in the absorption tower 41 to proceed optimally. Further, upon determining the oxygen content exiting the absorption tower 41, the skilled person will also weigh out the benefits of increasing the oxygen content in the absorption tower 41, in particular a reduced tower size due to improved absorption, against the drawback of a higher gas volume downstream the absorption tower 41 implying equipment, such as heat exchangers, of a larger size, for heating tail gas.

As defined herein, means for measuring the temperature are any means suitable for measuring and indicating the temperature in the ammonia oxidation burner. In particular, the means for measuring the temperature is a thermocouple or a thermocouple or a thermometer suitable for measuring and indicating a temperature as high as 1000° C. More in particular, the means for measuring the temperature is an infrared thermometer for measuring and indicating a temperature as high as 1000° C.

### EXAMPLES

### 1. Recirculation of Tail-Gas at 99%

Reference is made to FIG. 2. Ammonia 32 was mixed with compressed air 34 in a mixing apparatus 35. The resulting ammonia/compressed air mixture 14 was fed to an ammonia converter 37, at a temperature ranging from 800 to 950° C. and operating at a pressure of 8 bara. The oxygen to ammonia molar ratio at the inlet of the ammonia converter 37 was at least 1.25. In the ammonia converter 37, ammonia was oxidized over a mixed platinum/rhodium catalyst, thus obtaining a NOₓ gas/steam mixture 15, comprising water and nitric oxide (NO). The heat of the mixture coming out of the ammonia converter was recovered by producing steam for export to a steam grid, for supplying the steam turbine 51, and also for heating the tail gas 5 as will be described below. The NOₓ gas/stream mixture was subsequently cooled down in heat exchangers (not shown) and in a gas cooler/condenser 38 to a temperature where the water condenses, and an aqueous diluted nitric acid mixture 17 was separated from a gaseous NOₓ stream 22. The aqueous diluted nitric acid mixture 17 was directed to an absorption tower 41. The gaseous NOₓ stream 22 was sent to the absorber unit 6 too. Inside the absorber unit 6, the NOₓ gas reacted with water to produce the tail and a stream of raw nitric acid also containing residual NOₓ gas, which was fed to a bleacher 57. The oxygen content in the tail gas 5 was maintained at 3% using the bleaching gases 61 of the bleacher 57, supplied downstream the ammonia converter 37 and upstream the absorption tower 41. The tail gas stream 5 was pressurized using a gas compressor 53, thereby producing a pressurized tail gas. The pressurized tail gas was consecutively heated in a heat exchanger 73, treated in a De-NOx unit 71 and then heated in the tail gas heater 43 to 460° C., using the heat from the gaseous NOₓ stream 15, thereby producing a pressurized and heated tail gas. The pressurized and heated tail gas was used for heating the pressurized tail gas in the heat exchanger 73 and split over a T-tube 55, such that 99% of the tail gas stream was split, into a first tail gas stream 52 and an additional tail gas stream 74. The first tail gas stream 52 was mixed with an oxygen-rich gas 50 having a pressure of 9 bara, thereby providing an oxygen-containing gas 56 in the absence of further pressurized air 34 being supplied, such that additional tail gas 5 could be produced in the absence of an air compressor, and pressurized, heated, split and recirculated to the ammonia converter 37, together with the oxygen-rich gas 50. The amount of the oxygen-rich gas 50 fed to the process was controlled in order to ensure that the oxygen to ammonia molar ratio at the inlet of the ammonia converter 37 was measured and, in case it was lower than 1.25, the amount of the oxygen-rich gas 50 was adjusted, such that the oxygen to ammonia molar ratio at the inlet of the ammonia converter 37 was at least 1.25. The temperature inside the ammonia converter 37 was measured and established to have remained in the range of 800 to 950° C. The second tail gas stream 74 was sent to the tail gas expander 7. The residual NOₓ gas in the raw nitric acid stream 27 was then stripped out with a gaseous medium 60 such as an oxygen-containing gas or air, inside the bleacher unit 57; the bleacher unit was generally operated at about the same pressure as the ammonia converter of 8 bara. The drive power for the gas compressor 53 originated from the tail gas expander 7 and the steam turbine 51. The net power associated to the compressor 53 was 30 kWh/t 100% HNO₃. This power was provided by the steam turbine 51 and was provided by the tail gas expander 7 or the steam turbine 51 or an electrical motor. The specific steam export amounts to 1300 to 1500 kg/t nitric acid, which compares to a specific steam export of 200 to 600 kg/t nitric acid in a conventional mono pressure nitric acid production plant.

### 2. Recirculation of Tail-Gas at 76%

Reference is made to FIG. 2. Ammonia 32 was mixed with compressed air 34 in a mixing apparatus 35. The resulting ammonia/compressed air mixture 14 was fed to an ammonia converter 37, at a temperature ranging from 800 to 950° C. and operating at a pressure of 8 bara. The oxygen to ammonia molar ratio at the inlet of the ammonia converter 37 was at least 1.25. In the ammonia converter 37, ammonia was oxidized over a mixed platinum/rhodium catalyst, thus obtaining a NOₓ gas/steam mixture 15, comprising water and nitric oxide (NO). The heat of the mixture coming out of the ammonia converter was recovered by producing steam for export to a steam grid, for supplying the steam turbine 51, and also for heating the tail gas 5 as will be described below. The NOₓ gas/stream mixture was subsequently cooled down in heat exchangers (not shown) and in a gas cooler/condenser 38 to a temperature where the water condenses, and an aqueous diluted nitric acid mixture 17 was separated from a gaseous NOₓ stream 22. The aqueous diluted nitric acid mixture 17 was directed to an absorption tower 41. The gaseous NOₓ stream 22 was sent to the absorber unit 6 too. Inside the absorber unit 6, the NOₓ gas reacted with water to produce the tail and a stream of raw nitric acid also containing residual NOₓ gas, which was fed to a bleacher 57. The oxygen content in the tail gas 5 was maintained at 3% using the bleaching gases 61 of the bleacher 57, supplied downstream the ammonia converter 37 and upstream the absorption tower 41. The tail gas stream 5 was pressurized using a gas compressor 53, thereby producing a pressurized tail gas. The pressurized tail gas was consecutively heated in a heat exchanger 73, treated in a De-NOx unit 71 and then heated in the tail gas heater 43 to 460° C., using the heat from the gaseous NOₓ stream 15, thereby producing a pressurized and heated tail gas. The pressurized and heated tail gas was used for heating the pressurized tail gas in the heat exchanger 73 and split over a T-tube 55, such that 76% of the tail gas stream was split, into a first tail gas stream 52 and an additional (second) tail gas stream 74. The first tail gas stream 52 was mixed with oxygen-rich gas 50 having a pressure of 9 bara, thereby providing an oxygen-containing gas 56 in the absence of further pressurized air 34 being supplied, such that additional tail gas 5 could be produced in the absence of an air compressor, and pressurized, heated, split and recirculated to the ammonia converter 37, together with an oxygen-rich gas 50. The amount of the oxygen-rich gas 50 fed to the process was controlled in order to ensure that the oxygen to ammonia molar ratio at the inlet of the ammonia converter 37 was measured and, in case it was lower than 1.25, the amount of the oxygen-rich gas 50 was adjusted, such that the oxygen to ammonia molar ratio at the inlet of the ammonia converter 37 was at least 1.25. The temperature inside the ammonia converter 37 was measured and established to have remained in the range of 800 to 950° C. The second tail gas stream 74 was sent to the tail gas expander 7. The residual NOₓ gas in the raw nitric acid stream 27 was then stripped out with a gaseous medium 60 such as an oxygen-containing gas or air, inside the bleacher unit 57; the bleacher unit was generally operated at about the same pressure as the ammonia converter of 8 bara. The drive power for the gas compressor 53 originated from the tail gas expander 7 and the steam turbine 51. The net power associated to the compressor 53 was −19.6 kWh/t 100% HNO₃. This power was provided by the steam turbine 51 and was provided by the tail gas expander 7 or the steam turbine 51 or an electrical motor. The specific steam export amounts to 1500 to 1700 kg/t nitric acid, which compares to a specific steam export of 200 to 600 kg/t nitric acid in a conventional mono pressure nitric acid production plant.

1. A production plant for producing nitric acid at reduced power consumption and reduced emissions, comprising:
a source of a pressurized oxygen-rich gas;
a mixing apparatus downstream the source of the oxygen-rich gas, for mixing a first oxygen-containing gas with an ammonia gas stream, to produce an ammonia/oxygen-containing gas mixture;
an ammonia converter operable at a pressure P1, for oxidising ammonia in the ammonia/oxygen-containing gas mixture, to produce a NOₓ gas/steam mixture, comprising water and nitric oxide;
a means for regulating a concentration of ammonia and/or of oxygen in the ammonia converter, including a means for controlling a flow of the oxygen-rich gas and/or a means for controlling a flow of the ammonia gas stream, for maintaining the oxygen to ammonia molar ratio inside the ammonia converter at a ratio of at least 1.2;
a gas cooler/condenser downstream the ammonia converter, to produce an aqueous diluted nitric acid mixture and a gaseous NOₓ stream;
an absorption tower, downstream the gas cooler/condenser, for absorbing the NOₓ gases from the gaseous NOₓ stream in water, to produce a stream of raw nitric acid containing residual NOₓ gas and a tail gas comprising NOₓ gases, comprising an absorption tower tail gas outlet for evacuating the tail gas;
a supply for a second oxygen-containing gas, for supplying oxygen to a NOx gas containing stream between the ammonia converter and the absorption tower, for obtaining a tail gas containing—at least 0.5% by volume oxygen; and
a tail gas heater, positioned upstream from the gas cooler/condenser, for heating a tail gas stream with the heat from the NOₓ gas/steam mixture coming from the ammonia converter;
characterized in that the production plant further comprises:
a means for splitting a tail gas into a first tail gas stream and a second tail gas stream, wherein the first tail gas stream is in fluid communication with the oxygen-rich gas, and wherein the mixing of the oxygen-rich gas and the first tail gas stream provides the first oxygen-containing gas; and
a means for pressurizing a gas, located anywhere located anywhere in the fluid communication between the absorption tower and the mixing apparatus, or anywhere between the ammonia converter and the absorption tower, to provide the first tail gas stream at a pressure P1.

2. The production plant for producing nitric acid according to claim 1, comprising a source of pressurized air for pressurizing the production plant during startup, in fluid communication with a system comprising:
a source of a pressurized oxygen-rich gas;
a mixing apparatus downstream the source of the oxygen-rich gas, for mixing a first oxygen-containing gas having a pressure P1 with an ammonia gas stream, to produce an ammonia/oxygen-containing gas mixture;
means for measuring an oxygen concentration in the first oxygen-containing gas;
means for adjusting the concentration of oxygen in the first oxygen-containing gas such that the oxygen to ammonia molar ratio at an inlet of an ammonia converter is at least 1.2;
means for adjusting supply of the ammonia gas stream to the mixing apparatus;
an ammonia converter operable at a pressure P1, wherein pressure P1 is equal to or lower than the pressure of the source of oxygen-rich gas, for oxidising ammonia in the ammonia/oxygen-containing gas mixture, to produce a NOₓ gas/steam mixture, comprising water and nitric oxide;
means for measuring a temperature in the ammonia converter;
a gas cooler/condenser downstream the ammonia converter, to produce an aqueous diluted nitric acid mixture and a gaseous NOₓ stream;
an absorption tower, downstream the gas cooler/condenser, for absorbing NOₓ gases from the gaseous NOₓ stream in water, to produce a stream of raw nitric acid containing residual NOₓ gas and a tail gas comprising NOₓ gases, comprising an absorption tower tail gas outlet for evacuating the tail gas;
means for measuring the concentration of oxygen in a tail gas stream downstream the absorption tower;
a supply for a second oxygen-rich gas, for supplying oxygen between the ammonia converter and the absorption tower, for obtaining a tail gas containing at least 0.5% by volume oxygen; and
a tail gas heater, positioned upstream from the gas cooler/condenser, for heating the tail gas coming from the absorption tower to a temperature up to 650° C. with the heat from the NOₓ gas/steam mixture coming from the ammonia converter;
characterized in that the system further comprises:
means for pressurizing a gas to a pressure P1, located anywhere downstream the absorption tower, or anywhere between the ammonia converter and the absorption tower, or upstream the ammonia converter in the first oxygen-containing stream or in the ammonia/oxygen-containing gas mixture;
means for splitting a stream of tail gas downstream the absorption tower into a first tail gas stream, in fluid communication with the oxygen-rich gas, and a second tail gas stream; and
means for adjusting an amount of tail gas being split into the first tail gas stream and the second tail gas stream.

3. The production plant according to claim 1, wherein the production plant further comprises one or more of:
a heat exchanger, for exchanging heat between the tail gas and the stream of tail gas exiting the tail gas heater, wherein the means for splitting is positioned downstream the heat exchanger, and wherein the means for pressurizing is located upstream the heat exchanger;
a De-NOₓ treatment unit; and
a steam turbine, wherein the steam turbine can at least partly power the means for pressurizing.

4. The production plant according to claim 1, further comprising a bleacher comprising an inlet for an oxygen-rich bleaching gas, and an outlet for bleaching gases or off-gases, and wherein the bleaching gases or off-gases are in fluid communication with any stream between the ammonia converter and the absorption tower, such that the second oxygen-containing gas is at least partly provided by the bleaching gases or off-gases.

5. The production plant according to claim 4, wherein part of the oxygen-rich gas or part of the first oxygen-containing gas or part of the tail gas is in fluid communication with the inlet of the bleacher, such that the oxygen-rich bleaching gas is at least partly provided by part of the oxygen-rich gas or part of the first oxygen-containing gas or part of the tail gas stream downstream the means for pressurizing.

6. The production plant according to claim 4, wherein the oxygen-rich gas, the second oxygen-containing gas, the oxygen-rich bleaching gas and the oxygen-rich off-gases are all at least partly provided by a high pressure water electrolyzer.

7. The production plant according to claim 3, further comprising a tail gas expander for expanding the second tail gas stream to atmospheric pressure, to produce an expanded tail gas, wherein the means for pressurizing can at least partly be powered by the tail gas expander or by the steam turbine or by a power source.

8. The production plant according to claim 2, wherein the fluid communication between the source of pressurized air and the system is in direct fluid communication with the oxygen-rich gas.

9. A method for producing nitric acid at reduced power consumption and reduced emissions, in the production plant according to claim 1, comprising steps of:
prior to step c), providing or preparing an oxygen-rich gas and a first oxygen-containing gas, and providing an ammonia gas stream;
c) supplying the ammonia gas stream and the first oxygen-containing gas to the mixing apparatus, thereby producing the ammonia/oxygen-containing gas mixture;
d) oxidizing ammonia in the ammonia/oxygen-containing gas mixture in the ammonia converter at a pressure P1, thereby producing a gaseous NOx gas/steam mixture, comprising water and nitric oxide;
e) separating and condensing steam in the gas cooler/condenser, thereby generating an aqueous diluted nitric acid mixture and a gaseous NOx stream;
f) absorbing the gaseous NOx stream in the absorption tower, thereby producing the stream of raw nitric acid containing residual NOx gas and the tail gas comprising NOx gases; and
g) heating the tail gas in the tail gas heater with the gaseous NOₓ gas/steam mixture;
characterized in that the method further comprises steps of:
h) pressurizing a gas stream located anywhere downstream the absorption tower, or anywhere between the ammonia converter and the absorption tower, or upstream the ammonia converter in the first oxygen-containing stream or in the ammonia/oxygen-containing gas mixture, to a pressure P1 with the means for pressurizing;
i) splitting the tail gas with the means for splitting into a first tail gas stream and a second tail gas stream; and mixing the first tail gas stream with the oxygen-rich gas, thereby obtaining the first oxygen-containing gas;
k) adjusting the flow of the oxygen-rich gas being mixed in step i) or the flow of the ammonia gas stream in step c to maintain the oxygen to ammonia molar ratio inside the ammonia converter at a ratio of at least 1.2;
o) adjusting the flow of a second oxygen-containing gas, for obtaining a tail gas stream containing at least 0.5% by volume oxygen.

10. The method for producing nitric acid at reduced power consumption and reduced emissions according to claim 9, comprising steps of:
a) pressurizing the plant by supplying pressurized air having a pressure P1 in the plant;
b) inducing a pressurized air flow in the plant by operating the means for pressurizing using external power;
c) supplying the ammonia gas stream and a first oxygen containing gas to the mixing apparatus, thereby producing the ammonia/oxygen-containing gas mixture;
d) oxidizing ammonia in the ammonia/oxygen-containing gas mixture in the ammonia converter, thereby producing the gaseous NOx gas/steam mixture, comprising water and nitric oxide;
e) separating and condensing steam in the gas cooler/condenser, thereby generating the aqueous diluted nitric acid mixture and the gaseous NOx stream;
f) absorbing the gaseous NOx stream in the absorption tower, thereby producing the stream of raw nitric acid containing residual NOx gas and the tail gas comprising NOx gases; and
g) heating the tail gas in the tail gas heater to a temperature up to 650° C. with the gaseous NOx gas/steam mixture;
wherein the method further comprises steps of:
h) pressurizing a gas stream located anywhere downstream the absorption tower, or anywhere between the ammonia converter and the absorption tower, or upstream the ammonia converter in the oxygen-containing stream or in the ammonia/oxygen-containing gas mixture, with the means for pressurizing;
i) splitting a tail gas stream with a means for splitting into a first tail gas stream and a second tail gas stream, and mixing the first tail gas stream with the oxygen-rich gas, thereby providing the oxygen-containing gas;
j) measuring the oxygen concentration in the oxygen-containing gas;
k) if the oxygen concentration measured in step j) is such that the oxygen to ammonia molar ratio at an inlet of the ammonia converter less than 1.2, adjusting the supply of the oxygen-rich gas and being mixed in step i) or the supply of the ammonia gas stream in step c), such that the oxygen to ammonia molar ratio at the inlet of the ammonia converter is at least 1.2;
l) measuring the temperature in the ammonia converter;
m) adjusting the volume of the first tail gas stream being mixed in step i) or the supply of the ammonia gas stream supplied in step c′), if the temperature measured in step l) is outside a range of 800-950° C., such that the temperature in the ammonia converter is maintained in the range of 800-950° C.;
n) measuring the oxygen concentration in a tail gas stream downstream the absorption tower;
o) if the oxygen concentration measured in step n) is less than 0.5% by volume oxygen, adjusting the supply of the oxygen-rich gas between the ammonia converter and the absorption tower, such that the tail gas contains at least 0.5% by volume oxygen;
p) supplying the oxygen-containing gas to the mixing apparatus; and
q) repeating steps c) to p).

11. The method according to claim 9, wherein, in step h), at least part of the tail gas obtained from step f) is pressurized in the means for pressurizing, thereby generating a pressurized tail gas, and wherein the method further comprises steps of:
(h1) heating the pressurized tail gas with a tail gas stream downstream the tail gas heater and to be split step i), in a heat exchanger, thereby bringing the tail gas to be mixed in step i) to a temperature below 300° C.;
r) treating the tail gas in a De-NOₓ treatment unit before step g) and after step h1); and
s) recovering at least part of the steam generated in the ammonia converter in a steam turbine.

12. The method according to claim 9, further comprising the step of:
t) bleaching the stream of raw nitric acid containing residual NOₓ gas in a bleacher, thereby producing the bleached nitric acid.

13. The method according to claim 12, further comprising the step of:
u) supplying part of the oxygen-rich gas or part of the first oxygen-containing gas obtained in step i) or part of the tail gas obtained in step g), to an inlet of the bleacher in step t).

14. The method according to claim 9, further comprising steps of:
v) operating a water electrolyzer, thereby producing pressurized oxygen; and
w) providing, from the oxygen produced by the water electrolyzer in step v), at least part of the oxygen-rich gas, the second oxygen-containing gas, oxygen-rich bleaching gas, and oxygen off-gases.

15. The method according to claim 9, further comprising the step of:
x) expanding the second tail gas stream in the tail gas expander to atmospheric pressure, thereby producing the expanded tail gas.

16. The method according to claim 10, wherein, in step a) the pressurized air is supplied in the stream in direct fluid communication with the oxygen-rich gas.

17. (canceled)

18. A method for revamping a production plant for producing nitric acid, wherein the production plant comprises:
an air compressor for providing compressed air;
a mixing apparatus for mixing compressed air with an ammonia gas stream, to produce an ammonia/oxygen-containing gas mixture;
an ammonia converter, for oxidising ammonia in the ammonia/oxygen-containing gas mixture, to produce a NOₓ gas/steam mixture comprising water and nitric oxide;
a gas cooler/condenser downstream the ammonia converter, to produce an aqueous diluted nitric acid mixture and a gaseous NOₓ stream;
an absorption tower, downstream the gas cooler/condenser, for absorbing the NOₓ gases from the gaseous NOₓ stream in water, to produce a stream of raw nitric acid containing residual NOₓ gas and a tail gas comprising NOₓ gases, comprising an absorption tower tail gas outlet for evacuating the tail gas; and
a tail gas heater, positioned upstream from the gas cooler/condenser, for heating a tail gas stream with the heat from the NOₓ gas/steam mixture coming from the ammonia converter;
into a production plant according to claim 1, comprising steps of:
introducing a source of pressurized air in fluid communication with the production plant;
introducing a supply or source for an oxygen-rich gas, the mixing of the oxygen-rich gas and of compressed air providing part of a first oxygen-containing gas;
introducing a supply for second oxygen-containing gas, for supplying oxygen between the ammonia converter and the absorption tower, such that a tail gas stream contains at least 0.5% by volume oxygen;
introducing a means for regulating the concentration of oxygen in the ammonia converter and/or of the ammonia gas stream, including a means for controlling the flow of the oxygen-rich gas and/or a means for controlling the flow of the ammonia gas stream, for maintaining the oxygen to ammonia molar ratio inside the ammonia converter at a ratio of at least 1.2;
introducing a means for splitting a tail gas stream into a first tail gas stream and a second tail gas stream, wherein the first tail gas stream is in fluid communication with the oxygen-rich gas, thereby providing the first oxygen-containing gas;
introducing a means for pressurizing a gas to a pressure P1 located anywhere in the fluid communication between the absorption tower and the mixing apparatus, or between the ammonia converter and the absorption tower, to provide the first tail gas stream at a pressure P1; and
removing the air compressor.

19. The method according to claim 18, wherein the supply or source for the oxygen-rich gas is a high pressure water electrolyzer.

20. The method according to claim 18, wherein the oxygen to ammonia molar ratio inside the ammonia converter is maintained at a ratio between 1.2 and 9.

21. The production plant according to claim 1, wherein the source of the pressurized oxygen-rich gas is a high pressure water electrolyzer.

22. The method according to claim 9, wherein the oxygen to ammonia molar ratio inside the ammonia converter is maintained at a ratio between 1.2 and 9.

23. The method according to claim 10, wherein the ammonia is oxidized in the ammonia/oxygen-containing gas mixture in the ammonia converter at a pressure equal to or lower than P1 and a temperature ranging from 800 to 950° C.
